(19) United States
(12) Patent Application Publication
(10) Pub. No.: US 2012/0158510 A1
(43) Pub. Date: Jun. 21, 2012

(54) Targeted Service Delivery to Location and Event Specific Audiences

(76) Inventor: Paramjit S. Gill, Ottawa (CA)

(21) Appl. No.: 13/297,618

(22) Filed: Nov. 16, 2011

Related U.S. Application Data
(63) Continuation-in-part of application No. 13/098,153, filed on Apr. 29, 2011.

(30) Foreign Application Priority Data
Apr. 30, 2010 (CA) 2702240

(51) Int. Cl. G06Q 30/02

(52) U.S. Cl. 705/14.58

(57) ABSTRACT

A method or system to display targeted message based on a location parameter is provided. The system and method utilize event information to create a more immersive experience for an Event Participant that is physically present at an event and as a result becomes more receptive to target marketing messages. Also provided is a new computer interfaces to create a more engaging experience when attending an event remotely and as a result be more receptive to target marketing messages.

### CROSS-REFERENCE

This application is a continuation-in-part of application Ser. No. 13/098,153, entitled “Targeted Service Delivery to Location and Event Specific Audiences”, filed Apr. 29, 2011, which is incorporated by reference in its entirety.

### BACKGROUND

Most events such as a sporting event, a professional conference, a concert or a public gathering such as a political rally are time limited and location specific. Each attendant or participant for those events requires information before and during the course of the events as well as participate directly or indirectly in the event. Traditionally, this information requirement is satisfied by printed programs or other passive media such as bulletin boards or video displays. The problems with a passive medium are the inability to update the information in real time, the inflexibility of adapting the medium for other uses or their limited impact on audiences that are not physically present at the event.

Events also represent a unique marketing opportunity for a marketer. Each participant in an event represents a known demographic representing an ideal subject for the delivery of targeted advertising as well as an opportunity to provide value added services. In the past, an organizer of an event requires dedicated resources in order to capitalize on this opportunity. An example of this would be special sponsorships for an event or facilities to handling sales and service of goods relating to the event. The creation and maintenance of those marketing relationships and services are problematic.

The popularity of the Internet has provided some solutions to those problems arising from the maintenance and participation of an event as well as providing an opportunity for targeted marketing. A website can offer appropriate and relevant up-to-date program information, provide a venue for remote participation through services such as forums or discussion boards as well as incorporating targeted advertising. However, traditional website information can be inconvenient to access as well as not providing an engaging or immersive experience. As a result, the effectiveness of the targeted advertising can be reduced. A new system and method is described which solves those problems by using the location of the user as a key parameter to provide specific and relevant services for a specific event. In the case where the event participants are not physically present at the event, to use the latest developments in user interface design and computing technology to create a more interactive and engaging experience.

A new process and method is described that can provide relevant up-to-date information and services directly to event participants and at the same time offer a more compelling opportunity for targeted marketing. This process and method uses an event participant's geographical location information as a criterion to access location specific event information and services. In addition, a marketer can also create targeted advertising or provide additional service based on this information.

### DESCRIPTION OF DRAWINGS

FIG. 1—An overview of the system and method is provided in FIG. 1.

FIG. 2—Flow chart describing the interactions between the Event Organizer, the Information Broker and the Marketer before an Event.

FIG. 3—Flow chart describing the interactions between the Event Organizer and Event Participant during registration for a registered event.

FIG. 4—Flow chart describing the interactions between the Event Organizer, the Information Broker and the Event Participant during the Event.

FIG. 5—Flow chart describing the interactions between the Event Organizer, the Information Broker and the Marketer after the Event

### PROCESS AND METHOD

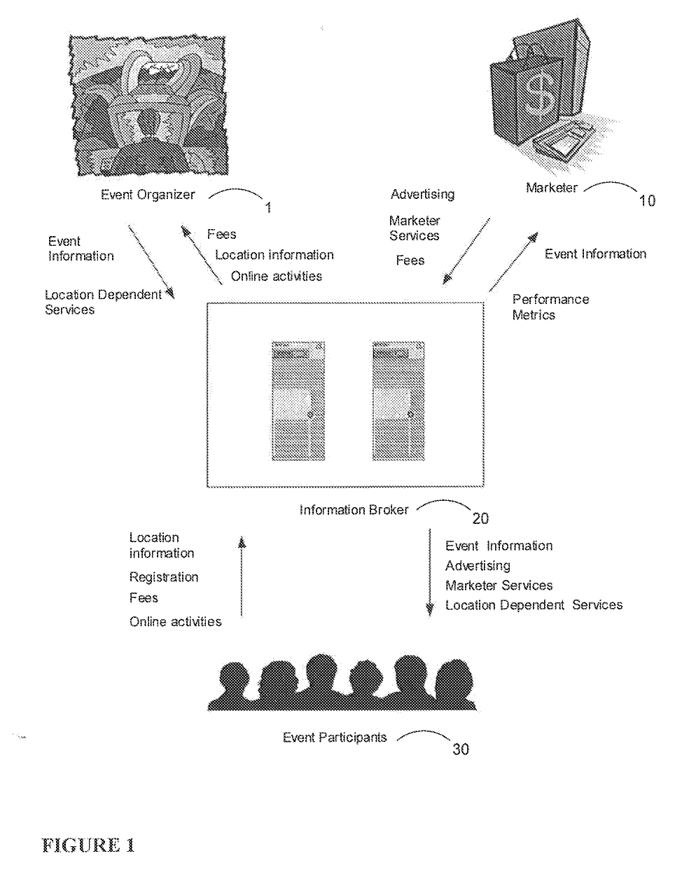

An overview of the system and method is provided in FIG. 1. In FIG. 1, The Event Organizer (1) is the coordinator for the event. This entity has access to information about the event as well as ownership of the event. Examples of an Event are a sporting event, a professional meeting, a public gathering or exhibition. Examples of an Event Organizer can be a sport team franchise, a casino, a professional association or the owner of the facility where said event is to be held. An Event Organizer is responsible for the schedule of the event, any information relevant to the event and services specific to the event. An example of relevant information includes information on participants, real time updates during the event. Examples of services include various video feeds capturing the atmosphere of the event or specialized activities to engage the participants during the event. The Event Organizer can optionally receive participant information as well as fees associated with the event. Example of participant information includes any type of demographic information which is obtained through a registration process. The Event Organizer can receive the Location Information for the Event Participant (30) through the Information Broker (20). Based on this Location Information, the Event Organizer (1) can provide Location Dependant Services to the Participant.

The Marketer (10) represents organizations that want to deliver a targeted advertising message or provide a Marketer Service to the Event Participants (30) during the event. Examples of a targeted advertising message could be text information delivered to the Event Participants or promotional material given to the participant. Examples of a Marketer service could include the sale of Event related material such as branded goods or food and drinks or free item giveaways during the event. The free item giveaways to the Event Participant may require some action from the Event Participant such as proceeding to a specific location or performing a certain task, such as a scavenger hunt. The Marketer pays a fee for the ability to access the Event Participants. In return, the Marketer receives Event Information and various Performance Metrics associated with the activities of the Event Participants and their interaction with the advertising message or Marketer Service.

Event Participants (30) represent people that attend a particular event organized by the Event Organizer. Each Event Participant can be identified uniquely through an identifier and the physical location of the Event Participant. Example of an identifier can be a userID, a unique ticket, a membership number, a phone number or the MAC address of a device that uniquely identifies the user to be a Participant of this event. The Event Participant must also be able to provide their location information through their devices. This could be in the form of a GPS information, a triangulation location based on their Mobile devices or a geographical location based on the IP address of the access device. Once that information is provided, they can participate in the Location Dependent Services supplied by the Event Organizer (1). For example, the location parameter can tell the Event Organizer that the Event Participant is physically present at the event or that the Event Participant is interacting remotely with the event.

The Information Broker (20) is the central coordinator for the flow of information in this system and method. The Information Broker ensures that each Event Participant receives the relevant event information and location dependent services as well as the opportunity offered by the Marketer.

The system and method can be explained in terms of information flow amongst the members of the system during the three distinct time periods during the course of an event: Before, During and After an Event. The information flow is carried out through some form of communication network such as the Internet or other communication/data transfer networks. The Information is managed and manipulated by computing devices and databases that are well known in the art. The main requirement is that the Event Participant uses a device that can communicate to the information broker its location when required. Examples of such devices are Mobile Phones, a Personal Digital Assistance (PDA), portable computing devices, television sets or game consoles connected to a network such as the Internet. The determination of the location of a device is also well known in the art. This flow of information applies to the case where the Event Participants are physically at the Event or that the Event Participants are engaging in the event remotely.

Before the Event

Interaction Between Event Organizer, Information Broker and Marketer

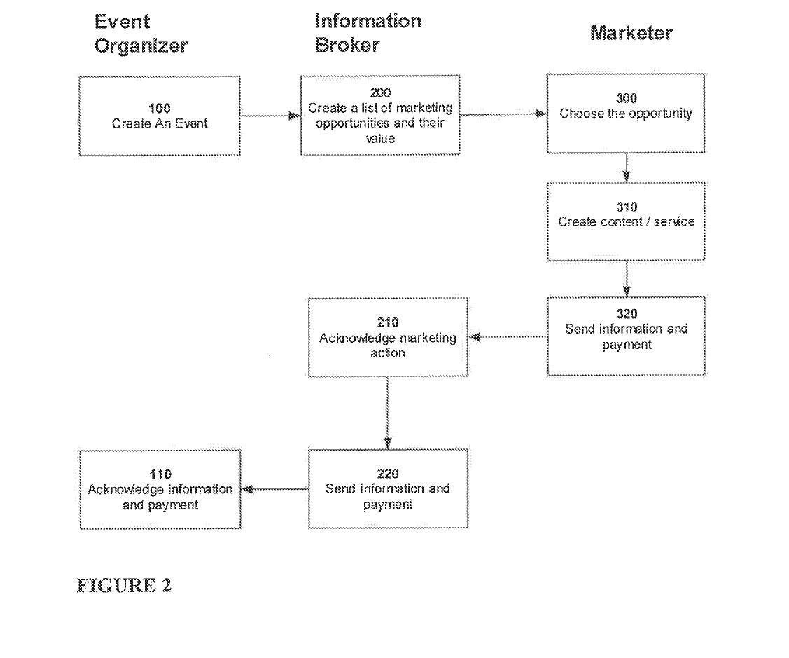

In the period before the Event, the main interaction in the process and system is between the Event Organizer, the Information Broker and the Marketer. The information flow in this process is presented in FIG. 2.

In FIG. 2, the Event Organizer creates an event (100). The Event Organizer sends the Information Broker information on an Event. Examples of this information include: description of event, number of participants, location, etc. The Event Organizer then sends a list of marketing opportunities available during the Event to the Information Broker. Marketing opportunities include advertising display, promotional opportunities, service availability, etc.

The Information Broker on receiving this information from the event organizer creates a list of marketing opportunities and a value associated with each opportunity (200). The Information Broker then makes this information available to the Marketer. This information is made available to the Marketer using any means of communication including a printed message, a telephone call or an Internet Posting. The Marketer then agrees on the value of the marketing opportunity and agrees on a compensation scheme for the marketing opportunity (300). The assigned value for the marketing opportunity can be a flat fee, or arrived at based on a priority list or in the form of an auction. The compensation scheme includes mutually agreed on performance metrics between the Information Broker and the Marketer. For example, a pay per view or pay per action are examples of performance metrics for advertising. The Marketer then creates and or prepares to offer the content and service (310). The Marketer then supplies the appropriate marketing information and payment to the Information Broker. (320) The Information Broker acknowledges the receipt of the marketing action (210) and sends the appropriate information to Event Organizer. The Event Organizer acknowledges the information and payment from the Information Broker (110) and continues with actions in preparation for the event (120).

Near the Start and During the Event

In the period near the start of the Event and during the Event, the Event Coordinator, the Marketer and the Event Participant interact through the Information Broker. The process and method can be constructed so that privacy of the Event participants is protected by the Information Broker.

Registration—Interaction Between the Event Organizer and Event Participant (Optional)

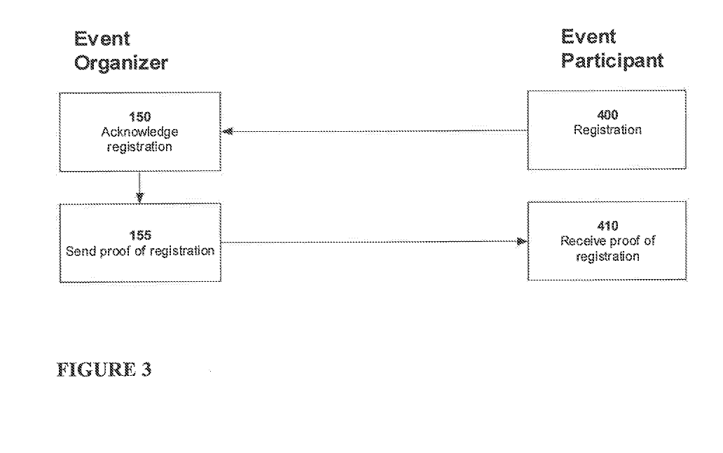

FIG. 3 is a summary of the interaction between the Event Organizer and Event Participant if a Registration process is necessary. This registration process is optional since there are events that are public, free and do not require prior registration. In the case of a private event, a registration process proceeds as follows. The Event participant registered for an Event (400). The registration process involves sending information to the Event Organizer. Examples of information include: identity, preferences and method of payment. This information could be transmitted by mail, through a telephone call or through the Internet. The Event Organizer then acknowledges this registration (150). This acknowledgment generally involves storing the Event Participant information in an organized way such as within a database. The Event Organizer will then send some proof of registration back to the participant. Examples or proof of registration are unique identifiers, a ticket, a receipt or an access code or instructions that will allow the Participant to access the Event. The registration process does not need to involve the Information Broker. However, in some cases, the Information Broker can act as a representative of the Event Organizer and handle the registration process.

In the case of an event that does not require registration, for example, a publically broadcast sporting event or a political rally, etc., the demographic information concerning the Event Participant can be estimated using known marketing techniques. This estimation can be used by the Marketer to create their targeted advertising message or service.

Interaction Between the Event Organizer, Information Broker and Event Participant

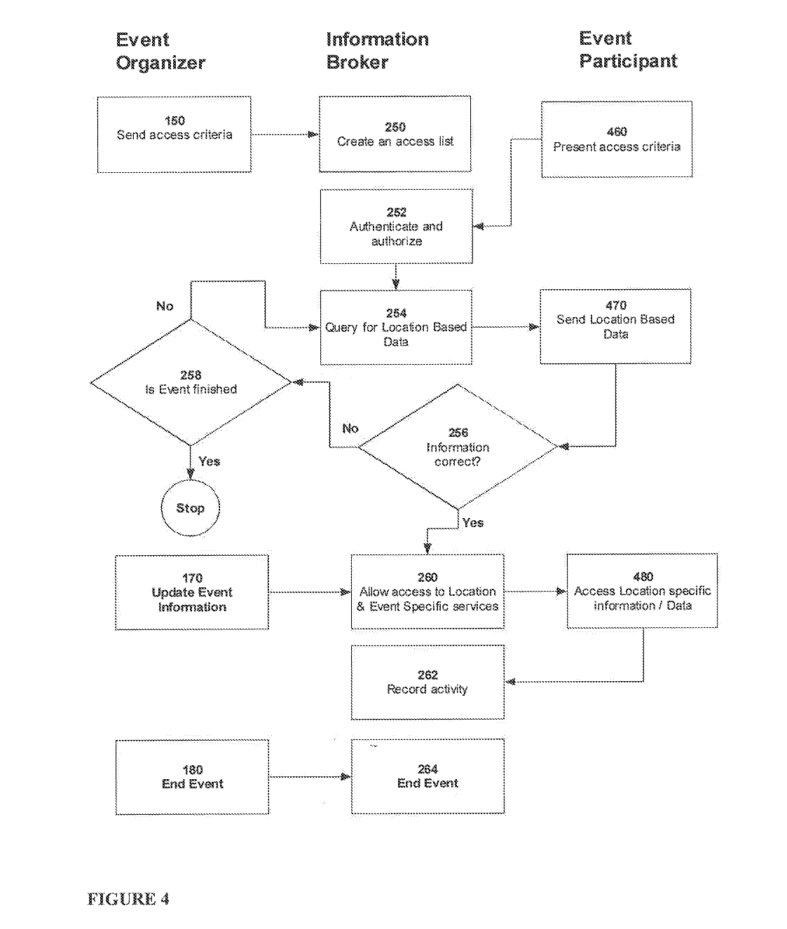

FIG. 4 is a flow chart describing the interaction between the Event Organizer, Information Broker and the Event Participant near the start of an Event and during the Event.

The Event Organizer sends one or more access criteria to the Information Broker (150). Example of access criteria are an userID from the registration process, proof of payment, particular input devices, particular range of IP address or event participants from a geographical region. The Information Broker then creates an access list for the event (250). The privacy of the Event Participant is protected if the Event Organizer does not send any personal identification information such as a name or addresses to the Information Broker.

The Event Participant presents one or more access criteria to the Information Broker (460). For example, the Event Participant can present the unique identifier such as a User ID or device ID to the Information Broker. The Information Broker will then authenticate and verify the access criteria (252). If the authentication step is successful, the Information Broker then communicates with the access device to verify its geographical location (254). If the geographic location is within the specific boundary of the Location Information (256), the Event Participant's device is allowed to access all the information and services specific to that geographical location (260). A boundary is understood to be a distance away from the center of a geographical location. This information and services include both the services offered by the Event Organizer as well as those provided by the Marketer. If the Location information is outside the boundary of the service, the Information Broker will continue to check the location of the device until the Event has ended (258).

During the Event, the Event Organizer can send Event Updates to the Information Broker (170). Examples of event updates could be video replays or notices of changes in schedules. The Information Broker can then relay these information updates and make it available to the Event Participants. After a certain time period, the Event Organizer can signal the end of the Event (180) and send this information to the Information Broker (254). At this point, the Information Broker performs the functions that are appropriate for the event. For example, remove access to information that is no longer relevant after the Event. (264).

After the Event

Interaction Between Information Broker, Marketer and Event Organizer

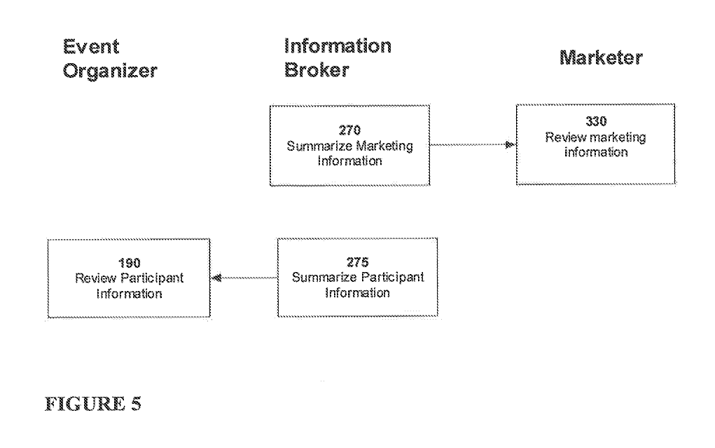

FIG. 5 is a flow chart describing the interaction between the Broker, Marketer and Event Organizer after the Event has occurred. After the Event, the Information Broker sends the appropriate performance metric to the marketer (270) so that the Marketer can review the Marketing Information (330). The Information Broker at this point can also provide a summary of Participant actions to the Event Organizer (275). Such information can be reviewed by the Event Organizer (190) as feedback information for the planning of the next event.

Details Specific to Event Participants Located in the Same Geographical Location as the Event

When the location parameter of the Event Participant matches the geographical location of the event, the Event Organizer can offer services and information specific to mobile, portable computing devices or via centrally located kiosks or computer terminals. Similarly, the Marketer can offer services specific to the geographical location. For example, discounts at a venue located at the geographical location of the event.

Details Specific to Event Participants Not Located in the Same Geographical Location as the Event

When the location parameter of the Event Participants does not match the geographical location of the event, the Event Organizer can offer remote services that enhance the users' experience of the Event. The Marketer also prefers that the Event Participants are more actively participating in the Event since they will then be more susceptible to the marketing message. There are two different systems that arise when the location parameter does not match the geographical location of the event: the Event Participant can Participate and Interact with the Event remotely or engage in an Immersive Experience of the Event. In each case, the difference is in the computing resources of the Event Participant and the amount of information provided by the Event Organizer.

Participate and Interact with the Event Remotely

In the case where the Event Participant is not at the same geographical location as the event the Event Participant can still participate and interact with the event remotely if the Event Participant is properly equipped. The requirement is that the Event Participant has one or more appropriate input devices and computing resources that are connected to a computing service provided by the Event Organizer. Examples of an appropriate input device include video camera, motion detection devices, mobile phones, devices with Natural User Interfaces (NUI) or Kinetic User Inter Interfaces (KUI) such as the Xbox Kinect, Wii MotionPlus, PlayStation Move or PlayStation Eye. The connection can be carried out for example through a standard Internet connection. Once connected, the Event Organizer can send the Event Participant information on the event. For example, live video of the event. The Event Participant can react to the information and provide feedback to the Event Organizer using the appropriate input device. For example, by jumping up and down through the Xbox Kinect system. This information is sent back to the Event Organizer and can then be incorporated as part of the event. In this example, the up and down motion of the Event Participant is included as part of the crowd action at the event.

In this case, the Event Participant is fully engaged in the event, the Marketer can provide a receptive marketing message and even provide services that are specific to the Event Participant's location.

Immersive Experience

In the case where the Event Participant is not at the same geographical location as the event, the Event Participant can still experience the event provided the Event Organizer can provide the appropriate detail information of the event to the Event Participant and that the Event Participant has the appropriate computational resources and display equipment. Example of appropriate detail information could include sound, video, three dimension data, holographic data of the event, etc. This information can be supplied through an appropriate network connection such as the Internet. Examples of appropriate computational resources and display equipment could include a home theatre system or a holographic projector. As a result the sight and sound of the event are replicated at the geographical location of the Event Participant.

In this case, the Event Participant is fully immersed in a virtual environment representing the event. The Marketer can provide the same marketing message as an Event Participant that is physically present at the event or the Marketer can provide a message that is based on the geographical location of the Event Participant.

### Embodiments

The applications of this system and method to specific events can demonstrate its functionality.

Sporting Event—Event Participant at the Geographical Location of the Event.

In this scenario, the Event Organizer represents a Sport Franchise, the Event represents a Game and Event Participant represents the sport fans that are going to the game.

Prior to the Game, the Sport Franchise decides that they will allow the following services for a Fan to access on their portable devices: (1) Instant Replays (2) Marketing Messages (3) Purchase of Food. This decision and supporting information is sent to an Information Broker. The Information Broker then sets up the service for displaying Instant Replays and then contacts various Marketers that are interested in providing Marketing Messages or Supplying Food Service. Each Marketer then pays the Information Broker for the ability to deliver the marketing service and message.

During registration, a Fan purchased a ticket with a mobile phone with GPS capabilities. The mobile phone number is declared to be the unique identifier for the event. This phone number is filed as a paid Event Participant for the game. This information is made available to the Information Broker.

On Game Day, the Fan shows up with the mobile phone. The mobile phone dials a number for the Information Broker. The mobile phone number is automatically verified as being a Paid Participant and once the mobile phone sends the geographical location confirming that the phone is at a particular event, the Fan is allowed entry to the Game and the portable device can access information associated with the Game.

During the Game, the Fan can access the Instant reply. Occasionally, text messages are displayed on the mobile device. The Fan can also order food service from this mobile device. Each action on the mobile device is recorded by the Information Broker. If the Fan leaves the vicinity of the Game, the system automatically prevents the mobile device from accessing the mobile services.

After the Game, the mobile services are closed. The Information Broker summarizes the activities of all Fans. The results are presented to each Marketer and the Sports Franchise as required.

Football Game. Event Participant is not physically located at the event but the Event Participant can send information to the event and participate in the event in real time.

The Event Participant has one or more input devices, for example, a video camera on a cell phone with motion sensors that can send information (the user's expression through the video camera, the movement of the cell phone) to a computing service for the event (a football game). The computing service can incorporate the Event Participant's information as part of the event. For example, the face of the user, can be incorporated into the crowd scene shown on a large TV at the event. The waving of the cell phone by the Event Participant triggers a signal which activates a display at the event to encourage more crowd participation at the event.

The information involving the location and current activity can also be shared with a third party to match the marketing requirements expressed by the third party; consequently, a targeted message can be delivered by the Third Party to the Event Participant on the cell phone.

Public Demonstration. Event Participant is physically not located at the event but the event can send information to the Event Participant to create a virtual immersive environment so that the user can interact with the event.

The Event Participant up to an event, for example, a public demonstration in Montreal, but the user is physically at a different location; for example, in Hong Kong. The Event Organizer (Public Demonstration Organizer) provides extensive information (crowd noise, video feed from all the cameras in the area, 3D or holographic information of the crowd) to the Event Participant. The Event Participant's computing service and display equipment can then use the information to create an immersive experience at the users location. For example, using a stereo system to create the noise of the crowd, viewing the game using different camera angles or using the 3D or holographic information to create a compelling vision of the demonstration. This immersive experience is designed to replicate the on location aspect of the event.

A third party (Marketer) has access to the information that the Event Organizer is engaged in this particular event and the third party can then target directed information to the user according to the available information about the user. For example, the Marketer can send a targeted message to be displayed while the Event Participant is involved in a Montreal Demonstration but is physically located in Hong Kong.

1. Method or system to display targeted message based on a location parameter.

2. Use of new computer interfaces to create a more engaging experience when attending an event remotely and as a result be more receptive to target marketing messages.

3. Use event information to create a more immersive experience for an Event Participant that is physically present at an event and as a result becomes more receptive to target marketing messages.
